(19) United States
(12) Patent Application Publication
(10) Pub. No.: US 2009/0157361 A1
(43) Pub. Date: Jun. 18, 2009

(54) METHOD OF WELL PLACEMENT MODELING AND GEOSTEERING

(76) Inventors: Farid TOGHI, Calgary (CA); JianXiong CHEN, Beijing (CN); RuiXia LIU, Beijing (CN); WenYan MA, Beijing (CN); Ming NIU, Meylan (FR)

Correspondence Address: Michael F. Hoffman;Hoffman Warnick LLC, 14th Floor, 75 State Street, Albany, NY, 12207, US

(21) Appl. No.: 12/332,492

(22) Filed: Dec. 11, 2008

Related U.S. Application Data
(60) Provisional application No. 61/012,940, filed on Dec. 12, 2007.

(51) Int. Cl. G06G 7/48; G06F 19/00

(52) U.S. Cl. 703/3

(57) ABSTRACT

The present invention is a method of establishing a geographical model of a wellbore that includes receiving a first geographical model of the wellbore and receiving measured log data and a trajectory of the wellbore. A first simulated tool response is simulated along the trajectory based on the first geographical model. A measured tool response is determined based on measured log data. A first portion of the first simulated tool response corresponding to a second portion of the measured tool response is found wherein the first portion and the second portion have substantially a same interval of length along the trajectory. The first portion and the second portion are compared to generate a second geographical model. The second geographical model can be used to geosteer a bottom hole assembly.

### FIELD OF THE INVENTION

The present invention relates generally to improved well placement based on real time data and geological modeling.

### BACKGROUND OF THE INVENTION

Wellbores drilled through earth formations to drain fluids such as petroleum are frequently drilled along a substantially horizontal trajectory in a petroleum reservoir to increase the drainage area in the reservoir. Because petroleum reservoirs are frequently located in layered earth formations, the position of such substantially horizontal wellbores with respect to the boundaries of the layers in the earth formations often has a material effect on the productivity of such wellbores. Estimation of distances to layer boundaries, therefore, is important for well landing and drain-hole positioning.

Techniques known in the art for estimation of the wellbore position with respect to layer boundaries include those which are indirectly based on well logging measurements in close-by (“offset”) wellbores. These techniques assume that the composition and the geometry of the formation layers proximate to the wellbore of interest are substantially the same as in the offset wellbores.

Another group of prior art techniques is based on the observation of features, referred to as “horns”, which appear in measurements made by electromagnetic-type well logging instruments, where this type of instrument approaches a layer boundary across which is a large contrast in electrical resistivity. Qualitative estimates of the distance between the instrument and the layer boundary are made by observing the magnitude of the horns.

The techniques known in the art for determining the position of the wellbore with respect to layer boundaries generally rely on well log measurements from a nearby (“offset”) well or a “pilot” well. A pilot well is a wellbore drilled substantially vertically through the same earth formations through which a horizontal wellbore is to be drilled. Typically, it is assumed that the layered structure observed in the offset well or pilot well extends to the geographic position of the proposed horizontal wellbore without much variation and without much change in attitude of the layer boundaries. This assumption is often inaccurate, particularly in the case of horizontal wells whose ultimate horizontal extent may be several kilometers from the position of the pilot well or offset well. Further, the prior art technique of observing horns on electromagnetic propagation measurements has several limitations. First, observation of the horns has not proven to be quantitatively accurate. Second, horns are generally observed on the well log only when the instrument is very close to the boundary.

Correction of the wellbore trajectory using horn observation techniques is often too late to avoid penetrating an undesirable layer of the earth formations, such as a water-bearing layer disposed below a hydrocarbon reservoir. The horn observation technique also depends on factors such as having a large resistivity contrast between adjacent layers of the formation, and whether the formation layer boundary is disposed at a “dip” angle suitable for generation of the horns in the resistivity measurements. Anisotropy in the electric conductivity and dielectric permittivity of the layers of the earth formations make the quantitative use of resistivity horns even more difficult.

Techniques known in the art for determining a wellbore trajectory using horn observation, and related techniques, are described, for example, in U.S. Pat. No. 5,241,273 issued to Luling; U.S. Pat. No. 5,495,174 issued to Tao et al; and U.S. Pat. No. 5,230,386 issued to Wu et al. Techniques known in the art for so-called “inversion” processing measurements from well logging instruments are described in a number of patents. See, for example, U.S. Pat. No. 6,047,240 issued to Barber et al; U.S. Pat. No. 5,345,179 issued to Habashy et al; U.S. Pat. No. 5,214,613 issued to Esmersoy; U.S. Pat. No. 5,210,691 issued to Freedman; and U.S. Pat. No. 5,703,773 issued to Tabarovsky et al.

Inversion processing techniques known in the art have as one primary purpose, among others, determining the spatial distribution of physical properties, particularly conductivity, of earth formations surrounding the well logging instrument. Inversion processing generally includes making an initial model of the spatial distribution of formation properties, calculating an expected response of the well logging instrument to the model, and comparing the expected response to the measured response of the logging instrument. If differences between the expected response and the measured response exceed a predetermined threshold, the model is adjusted and the process is repeated until the differences fall below the threshold. The model, after adjustment that results in the reduced differences, then represents a likely distribution of properties of the earth formations.

Inversion processing known in the art is primarily concerned with determining the values of the properties as well as their spatial distribution. It is typically assumed that the properties of the earth formations extend laterally away from the well logging instrument a sufficient distance so that any lateral variations in the formation properties do not materially affect the response of the logging instrument. In cases where this assumption is not true, such as where the well logging instrument axis is highly inclined with respect to various layer boundaries in the formations, improved inversion techniques account for localized instrument response anomalies near these boundaries. Generally, the inversion techniques known in the art, however, do not have as a primary purpose determining the position of the wellbore with respect to layer boundaries. An inversion processing method described in U.K. published patent application GB 2 301 902 A filed by Meyer discloses determining a distance from a well logging instrument to a layer boundary in an earth formation. U.S. Pat. No. 7,093,672 describes a method for geosteering during drilling using inversion methods.

There remains a need for improved method for geological modeling in wellbores and for real-time adjustment of geosteering during drilling horizontal wells.

### SUMMARY OF THE INVENTION

In one embodiment of the invention, there is a method of establishing a geographical model of a wellbore that includes receiving a first geographical model of the wellbore and receiving measured log data and a trajectory of the wellbore. A first simulated tool response is simulated along the trajectory based on the first geographical model. A measured tool response is determined based on measured log data. A first portion of the first simulated tool response corresponding to a second portion of the measured tool response is found wherein the first portion and the second portion have substantially a same interval of length along the trajectory. The first portion and the second portion are compared to generate a second geographical model.

In a second embodiment of the invention, there is a method for geosteering while drilling that includes receiving a first geographical model of the wellbore and receiving measured log data and a trajectory of the wellbore. A first simulated tool response is simulated along the trajectory based on the first geographical model. A measured tool response is determined based on measured log data. A first portion of the first simulated tool response corresponding to a second portion of the measured tool response is found wherein the first portion and the second portion have substantially a same interval of length along the trajectory. The first portion and the second portion are compared to generate a second geographical model. A bottom hole assembly is steered based on the second geographical model.

In a third embodiment of the invention, there is a system for geosteering while drilling that includes a computer having a processor and a memory wherein the memory stores a program having instructions for receiving a first geographical model of the wellbore and receiving measured log data and a trajectory of the wellbore. A first simulated tool response is simulated along the trajectory based on the first geographical model. A measured tool response is determined based on measured log data. A first portion of the first simulated tool response corresponding to a second portion of the measured tool response is found wherein the first portion and the second portion have substantially a same interval of length along the trajectory. The first portion and the second portion are compared to generate a second geographical model. A bottom hole assembly is steered based on the second geographical model.

Additional objects and advantages of the invention will become apparent to those skilled in the art upon reference to the detailed description taken in conjunction with the provided figures.

### BRIEF DESCRIPTION OF THE DRAWINGS

The present invention is illustrated by way of example and not intended to be limited by the figures of the accompanying drawings in which like references indicate similar elements and in which:

FIG. 1 shows a flow chart of a prior art system;

FIG. 2 shows a flow chart describing an embodiment of this invention;

### DETAILED DESCRIPTION

Advantages and features of the present invention may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

In well placement workflow, the first stage is to create the geological model for the well to be drilled. The geological model can be generated from seismic data or nearby drilled wellbores. The second stage is to plan the well path for the new well based on target(s) and well objective(s). Then tool response(s) will be simulated along the planned trajectory based on the tool string to be used.

During drilling the modeled logs based on the planned trajectory are not used any more. The modeled logs are recomputed based on real-time trajectory. In general modeled and real-time log responses will not match due to discrepancies between real subsurface structure and initial geological model.

A tool response correlation is to correlate the real-time measured data and model based simulated data. Based on the correlation the geological model will be modified and fine-tuned. The drilling target and the remaining trajectory may need to be modified accordingly based on the modified geological model to achieve the drilling objectives.

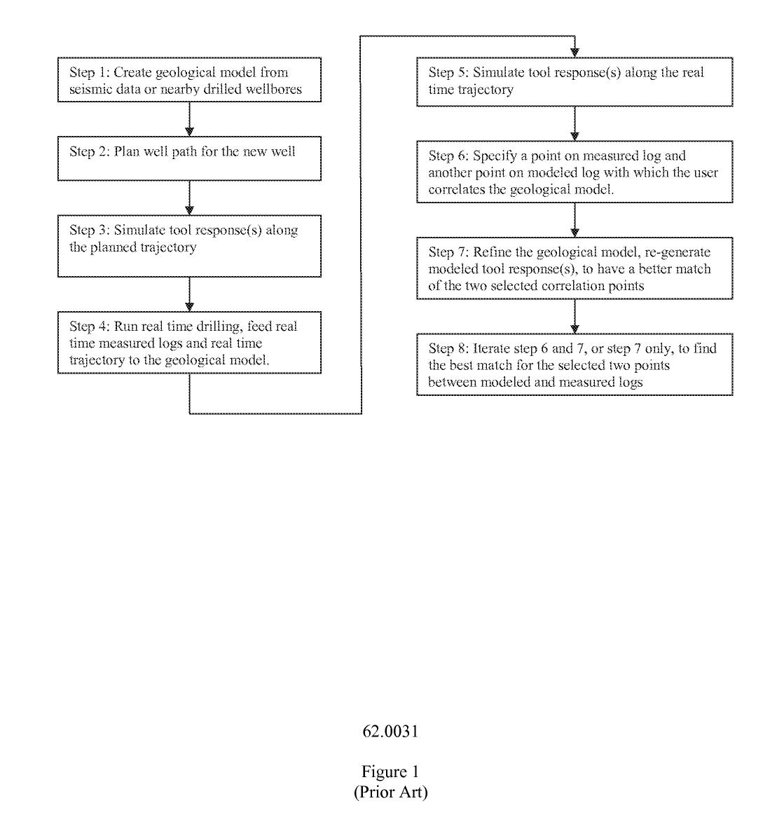

FIG. 1 is a flowchart of the prior method used to model geological formations. In this method a geological model is created from various information, such as seismic data or nearby drilled wellbores. The path for a new well is planed from this geological model. A tool response is simulated along the planned trajectory. During the drilling real time measured logs are collected along the trajectory. These measured logs are compared with the simulated tool response along the real time trajectory. The user specifies a point for correlation between the geological model and the measured logs along the real time trajectory. The geological model is refined based on the correlation. Steps 5, 6 and 7 can be iterated to find the best match between modeled and measured logs. Not shown is the adjustment of the steering in the bottom hole assembly after a the geological model is modified.

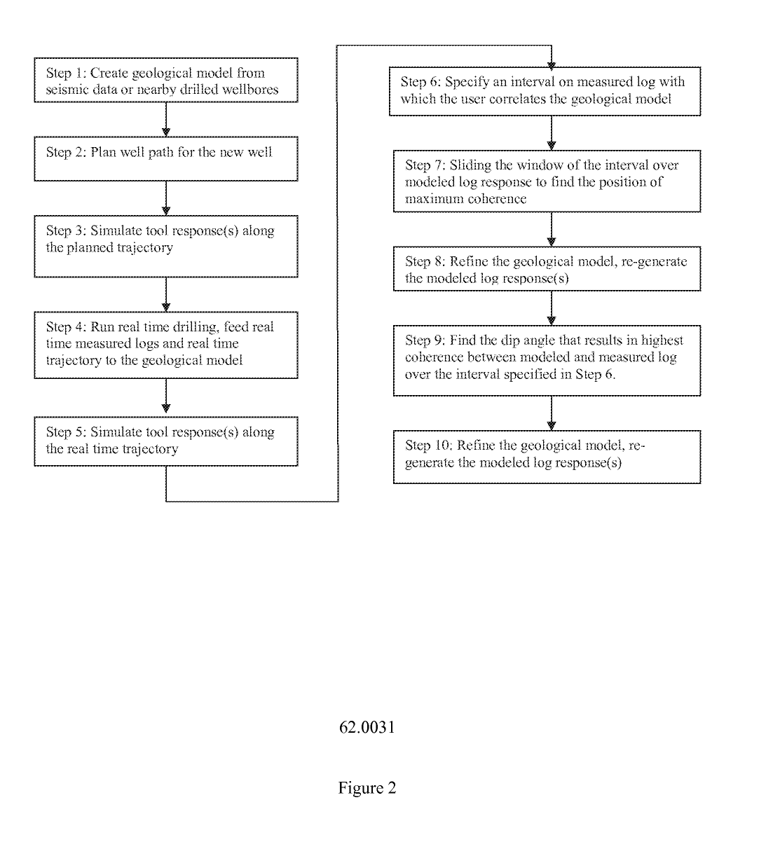

The novel approach proposed here takes into account the coherence of an interval rather than simple two discrete point correlations. Also an iterative technique is used to further fine-tune the refinement option, which is only based on geometric consideration. The apparent dip and proximity of boundaries affect some of the measurements and causes a more complicated tool response. Also slight changes in apparent dip could cause significant change on the quality of the correlation. The flow chart in FIG. 2 shows this novel approach.

As with previous methods the path for a new well is planed from a geological model. A tool response is simulated along the planned trajectory. During the drilling real time measured logs are collected along the trajectory (Steps 1-4 in FIG. 2). These measured logs are compared with the simulated tool response along the real time trajectory. In the Step 6 an interval on measured log response is specified. The interval includes the marker signature with which a user correlates to a geological model. The range or window of the interval is varied to find the position of maximum coherence between the geological model and the measured log response (Step 7). Modification and refinement of the geological model is performed (Step 8). Once the geological model is modified, the modeled logs are re-calculated based on the modified geological model and the real time trajectory. Not shown is the adjustment of the steering in the bottom hole assembly after a the geological model is modified.

Step 9 involves an optional iterative technique to further improve the correlation. This step can result in significant improvement if log responses used for correlation are sensitive to apparent dip. In this step the dip angle is iterated in a small window around the current dip. In each iteration, the forward model over the zone of interest (specified in first step) will be recomputed and compared to real-time measurement. The dip angle, which results in highest coherence between modeled and measured log is used for model refinement.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the disclosure has other applications in other environments. This application is intended to cover any adaptations or variations of the present disclosure. The following claims are in no way intended to limit the scope of the disclosure to the specific embodiments described herein.

We claim:

1. A method of establishing a geographical model of a wellbore, the method comprising:
receiving a first geographical model of the wellbore;
receiving measured log data and a trajectory of the wellbore;
simulating a first simulated tool response along the trajectory based on the first geographical model;
determining a measured tool response based on the measured log data;
finding a first portion of the first simulated tool response corresponding to a second portion of the measured tool response, the first portion and the second portion having substantially a same interval of length along the trajectory; and
comparing the first portion and the second portion to generate a second geographical model.

2. The method according to claim 1, wherein the comparing includes:
determining a difference between the first portion and the second portion in respective relative position with respect to the trajectory; and
updating the first geographical model based on the determined difference to generate the second geographical model.

3. The method according to claim 2, wherein the difference determining includes moving the first portion along the trajectory to find a position where the respective first simulated tool response matches the measured tool response of the second portion better than other positions along the trajectory.

4. The method according to claim 3, wherein the finding includes matching a trend of the simulated tool response within the first portion and a trend of the measured tool response within the second portion.

5. The method according to claim 1, wherein the comparing includes:
determining a difference between a dip angle of the first portion and a dip angle of the second portion; and
updating the first geographical model based on the determined difference to generate the second geographical model.

6. The method according to claim 5, wherein the determining a difference between a dip angle includes changing the dip angle of the first portion within a preset window to find a dip angle value with which the respective first simulated tool response matches the measured tool response of the second portion best within the present window of dip angle values.

7. The method according to claim 1, wherein the comparing is iterated until a second simulated tool response obtained based on the second geographical model matches the measured tool response to a preset extent.

8. A method for geosteering while drilling comprising:
receiving a first geographical model of the wellbore;
receiving measured log data and a trajectory of the wellbore;
simulating a first simulated tool response along the trajectory based on the first geographical model;
determining a measured tool response based on the measured log data;
finding a first portion of the first simulated tool response corresponding to a second portion of the measured tool response, the first portion and the second portion having substantially a same interval of length along the trajectory;
comparing the first portion and the second portion to generate a second geographical model;
steering a bottom hole assembly based on the second geographical model.

9. The method according to claim 8, wherein the comparing includes:
determining a difference between a dip angle of the first portion and a dip angle of the second portion; and
updating the first geographical model based on the determined difference to generate the second geographical model.

10. The method according to claim 9, wherein the determining a difference between a dip angle includes changing the dip angle of the first portion within a preset window to find a dip angle value with which the respective first simulated tool response matches the measured tool response of the second portion best within the present window of dip angle values.

11. A system for geosteering while drilling comprising:
a computer having a processor and a memory wherein the memory stores a program having instructions for:
receiving a first geographical model of the wellbore;
receiving measured log data and a trajectory of the wellbore;
simulating a first simulated tool response along the trajectory based on the first geographical model;
determining a measured tool response based on the measured log data;
finding a first portion of the first simulated tool response corresponding to a second portion of the measured tool response, the first portion and the second portion having substantially a same interval of length along the trajectory;
comparing the first portion and the second portion to generate a second geographical model; and
selecting a steering solution for the bottom hole assembly.

12. The system according to claim 11, wherein the comparing includes:
determining a difference between a dip angle of the first portion and a dip angle of the second portion; and
updating the first geographical model based on the determined difference to generate the second geographical model.

13. The system according to claim 12, wherein the determining a difference between a dip angle includes changing the dip angle of the first portion within a preset window to find a dip angle value with which the respective first simulated tool response matches the measured tool response of the second portion best within the present window of dip angle values.
